(19) United States
(12) Patent Application Publication
(10) Pub. No.: US 2010/0181910 A1
(43) Pub. Date: Jul. 22, 2010

(54) HIGH-PRESSURE DISCHARGE LAMP COMPRISING A STARTER ANTENNA

(75) Inventor: Marcus Jozef Henricus Kessels, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/664,442

(22) PCT Filed: Jun. 16, 2008
(86) PCT No.: PCT/IB2008/052361

§ 371 Date: Dec. 14, 2009

(30) Foreign Application Priority Data
Jun. 21, 2007 (EP) 07110756.9

(51) Int. Cl. H01J 61/54

(52) U.S. Cl. 313/594

(57) ABSTRACT

A high-pressure discharge lamp comprising an inner bulb (2) with a discharge space (3) containing an ionizable filling is described. Two electrodes (4,5) project from opposite sides into the discharge space (3). An outer bulb (13) surrounds the inner bulb (2) and a current-supply conductor (12) extends outside the outer bulb (13) for supplying an electric current to one of the two electrodes (5). A starter antenna (14) is connected to they current-supplyconductor (12). The starter antenna (14) passes through an opening (15) in the wall of the outer bulb (13) and extends towards the outer surface of the inner bulb (2).

### FIELD OF THE INVENTION

The invention relates to a high-pressure discharge lamp comprising an inner bulb with a discharge space containing an ionizable filling, and a first electrode and a second electrode projecting from opposite sides into said discharge space, an outer bulb surrounding said inner bulb and a current-supply conductor extending outside said outer bulb for supplying an electric current to the second electrode.

### BACKGROUND OF THE INVENTION

High-pressure discharge lamps of this type can be used for many applications, for example, as headlamps of automobiles. The inner bulb comprises the light source of the lamp and the outer bulb is made of a material that absorbs the ultraviolet radiation from the inner bulb. Such a high-pressure discharge lamp having an inner bulb and an outer bulb is disclosed in U.S. Pat. No. 5,736,811.

In general, a high-pressure discharge lamp of this type has the drawback that it requires a relatively high drive voltage to start the discharge of the gas in the discharge space.

The drive power source of the lamp must therefore be designed to generate a high starting voltage, for example, higher than 20 kV. Such a high voltage raises the manufacturing costs of the drive circuit of the lamp. Moreover, noise may be generated.

### OBJECT AND SUMMARY OF THE INVENTION

It is an object of the invention to provide a high-pressure discharge lamp comprising an inner bulb surrounded by an outer bulb for absorbing the ultraviolet radiation from the inner bulb, in which lamp an electric current is supplied to one of the electrodes through a current-supply conductor located outside the outer bulb, and in which the lamp has a relatively low starting voltage which can be reduced in a simple manner without the need of a gastight outer bulb.

This object is achieved in that a starter antenna is connected to said current-supply conductor, which starter antenna passes through an opening in the wall of the outer bulb and extends towards the outer surface of the inner bulb. The use of such a starter antenna is known and described in, for example, U.S. Pat. No. 6,380,679. The starter antenna must be proximate to the discharge space and therefore has to be located inside the outer bulb. By making use of an opening, or bore, in the wall of the outer bulb, the starter antenna can extend from the current-supply conductor outside the outer bulb to a location inside the outer bulb proximate to the outer surface of the inner bulb.

A part of the antenna is preferably located proximate to the first electrode, so that the discharge of gas in the discharge space can start in an effective way near the first electrode, while the voltage supplied to the lamp is much lower than the required voltage without the starter antenna.

In a preferred embodiment, at least a part of the antenna is made of a material comprising mainly Mo, or mainly W, or mainly an alloy of Fe, Cr and Al (also known as Kanthal), or mainly an alloy of Ni and Fe (also known as Nikrothal). Application of these materials has proved to be satisfactory.

The starter antenna preferably comprises a part that extends along a portion of the outer surface of the inner bulb. In a preferred embodiment, said part is a conductive layer coated on the outer surface of the inner bulb. In another preferred embodiment, said part is a conductive wire extending along the outer surface of the inner bulb.

The conductive layer preferably has the shape of a strip extending from a location proximate to the first electrode to a location proximate to the second electrode, which layer is connected by an electric conductor to the current-supply conductor outside the outer bulb through the opening in the wall of the outer bulb. At least the major part of the material of the layer is preferably tungsten (W), or antimony tin oxide (ATO), or indium tin oxide (ITO), or tin oxide. These materials have proved to be appropriate for the specific purpose.

At least the major part of the conductive wire extending along the outer surface of the inner bulb is preferably made of a material comprising mainly Mo, or mainly W, or mainly an alloy of Fe, Cr and Al (Kanthal), or mainly an alloy of Ni and Fe (Nikrothal). These materials have also proved to be appropriate for the specific purpose.

### BRIEF DESCRIPTION OF THE DRAWING

The invention will now be elucidated with reference to two embodiments of an automotive high-pressure discharge lamp.

In the drawing,

FIG. 1 is a sectional view of a first embodiment of the lamp;

FIG. 2 is a sectional view taken on the line II-II in FIG. 1; and

FIG. 3 shows a second embodiment of the lamp in a sectional view.

Only parts that are relevant for the elucidation of the invention are represented in the three schematic Figures. Similar parts of the two embodiments are denoted by the same reference numerals.

### DESCRIPTION OF EMBODIMENTS

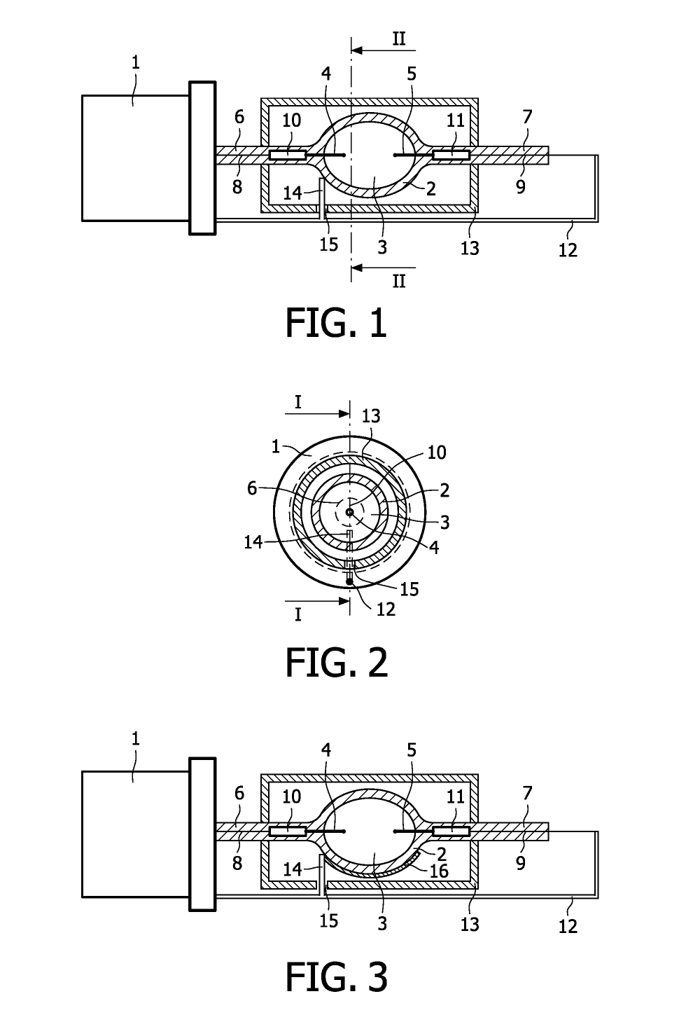

The first embodiment of the lamp is shown in FIGS. 1 and 2. The lamp has a base portion 1 of insulating material for fixing the lamp in a lamp holder, which base portion 1 is provided with electric contacts (not shown in the Figures) for connecting the lamp to corresponding electric power-supply contact means in the lamp holder. FIG. 1 shows the lamp in a sectional view, except for the base portion 1. The lamp further comprises an inner bulb 2 enclosing a discharge space 3 filled with an ionizable gas. Two electrodes 4, 5 are embedded in the transparent material of the inner bulb 2 and extend in the discharge space 3 from opposite sides. The inner bulb 2 has two end portions 6, 7 accommodating electric current-supply means. The current-supply means in each end portion 6, 7 comprise conductive wires 8, 9 and molybdenum foils 10, 11 connected to each other. The electrodes 4, 5 are connected to the molybdenum foils 10, 11, respectively.

Electric power is supplied from the base portion 1 to the first electrode 4 through the conductive wire 8 and molybdenum foil 10. Electric power to the second electrode 5 is supplied from the base portion 1 through current-supply conductor 12, conductive wire 9 and molybdenum foil 11. Conductor 12 is located outside the outer bulb 13 which surrounds the major part of the inner bulb 2. Up to this point, the lamp is similar to the lamp described in U.S. Pat. No. 5,736,811 and can be produced as described in this document.

According to the invention, the current-supply conductor 12 is connected to a conductive rod-shaped member 14 functioning as a starting antenna which extends through an opening 15 in the wall of the outer bulb 13. The end of the starting antenna 14 engages the outer surface of the inner bulb 2 proximate to the first electrode 4. The opening 15 may thus be relatively large or can closely surround the conductive member 14.

FIG. 3 shows the second embodiment of the lamp. This embodiment is similar to the first embodiment, but the starter antenna comprises a portion 16 extending along the outer surface of the inner bulb 2. The portion 16 may be a strip-shaped conductive layer 16 coated on the outer surface of the inner bulb 2. The rod-shaped member 14 contacts the conductive layer 16, and the starter antenna comprises both the rod-shaped member 14 and the strip-shaped conductive layer 16. Alternatively, the portion 16 may be a conductive wire extending along the outer surface of the inner bulb 2. The rod-shaped member 14 is connected to the conductive wire 16 and keeps it in position.

The embodiments described hereinbefore are only examples of a high-pressure discharge lamp according to the invention. Many other alternative embodiments of the lamp are possible.

1. A high-pressure discharge lamp, comprising:
an inner bulb defining a discharge space containing an ionizable filling,
a first electrode and a second electrode projecting from opposite sides into said discharge space,
an outer bulb surrounding said inner bulb
a current-supply conductor extending outside said outer bulb for supplying an electric current to the second electrode, and
a starter antenna disposed at least partially within said outer bulb and is connected to said current-supply conductor, wherein the starter antenna passes through an opening in the wall of the outer bulb and extends towards the outer surface of the inner bulb.

2. A high-pressure discharge lamp as claimed in claim 1, wherein a part of the antenna is located proximate to said first electrode.

3. A high-pressure discharge lamp as claimed in claim 1, wherein at least a part (14) of the antenna comprises a material selected from the group consisting of: Mo, W, an alloy consisting essentially of Fe, Cr and Al, and an alloy consisting essentially of Ni and Fe.

4. A high-pressure discharge lamp as claimed in claim 1, wherein the starter antenna comprises a part that extends along a portion of the outer surface of the inner bulb.

5. A high-pressure discharge lamp as claimed in claim 4, wherein said part comprises a conductive layer coated on the outer surface of the inner bulb.

6. A high-pressure discharge lamp as claimed in claim 5, wherein the conductive layer has the shape of a strip extending from a location proximate to the first electrode to a location proximate to the second electrode.

7. A high-pressure discharge lamp as claimed in claim 5, wherein the conductive layer comprises tungsten (W), antimony tin oxide (ATO), indium tin oxide (ITO), or tin oxide.

8. A high-pressure discharge lamp as claimed in claim 4, wherein said part is a conductive wire extending along the outer surface of the inner bulb.

9. A high-pressure discharge lamp as claimed in claim 8, wherein the conductive wire comprises a material selected from the group consisting of: Mo, W, or an alloy consisting essentially of Fe, Cr and Al, and an alloy consisting essentially of Ni and Fe.
